(19) United States
(12) Patent Application Publication
(10) Pub. No.: US 2004/0157645 A1
(43) Pub. Date: Aug. 12, 2004

(54) System and method of operation an array antenna in a distributed wireless communication network

(76) Inventors: Adrian David Smith, Kanata (CA); David Steer, Nepean (CA); Koon Hoo Teo, Nepean (CA)

Correspondence Address: SMART & BIGGAR/FETHERSTONHAUGH & CO., P.O. BOX 2999, STATION D, 55 METCALFE STREET, OTTAWA, ON, K1P5Y6, CA

(21) Appl. No.: 10/682,090

(22) Filed: Oct. 10, 2003

Related U.S. Application Data
(60) Provisional application No. 60/453,840, filed on Mar. 11, 2003.
(60) Provisional application No. 60/446,617, filed on Feb. 12, 2003.
(60) Provisional application No. 60/446,618, filed on Feb. 12, 2003.
(60) Provisional application No. 60/446,619, filed on Feb. 12, 2003.
(60) Provisional application No. 60/447,527, filed on Feb. 14, 2003.
(60) Provisional application No. 60/447,643, filed on Feb. 14, 2003.
(60) Provisional application No. 60/447,644, filed on Feb. 14, 2003.
(60) Provisional application No. 60/447,645, filed on Feb. 14, 2003.
(60) Provisional application No. 60/447,646, filed on Feb. 14, 2003.
(60) Provisional application No. 60/451,897, filed on Mar. 4, 2003.
(60) Provisional application No. 60/453,011, filed on Mar. 7, 2003.
(60) Provisional application No. 60/454,715, filed on Mar. 15, 2003.
(60) Provisional application No. 60/461,344, filed on Apr. 9, 2003.
(60) Provisional application No. 60/461,579, filed on Apr. 9, 2003.
(60) Provisional application No. 60/464,844, filed on Apr. 23, 2003.
(60) Provisional application No. 60/467,432, filed on May 2, 2003.
(60) Provisional application No. 60/468,456, filed on May 7, 2003.
(60) Provisional application No. 60/480,599, filed on Jun. 20, 2003.

(51) Int. Cl. H04Q 7/20

(52) U.S. Cl. 455/562.1

(57) ABSTRACT

Systems and methods of operating an array antenna are disclosed. The array antenna has configurable beamwidth and is operable in any of multiple operating modes associated with respective beamwidths. For example, operating an array antenna at a wide beamwidth for detecting incoming communication signals reduces scan times associated with individually scanning directional antennas. Switching to narrow beamwidth operation for subsequent exchange of communication signals provides higher antenna gain and reduces interference. Steering of beams and nulls in a gain pattern of an array antenna further reduces interference on wireless communication links. The benefits of each beamwidth are thereby exploited for particular functions, while many of the drawbacks of each beamwidth for other functions are avoided.

### CROSS-REFERENCE TO RELATED APPLICATION

This application claims priority from United States Provisional Patent Application Serial No. 60/453,840, filed on Mar. 11, 2003. The entire contents of this provisional application are hereby incorporated herein by reference.

This application is also related to the following Provisional Patent Applications filed in the U.S. Patent and Trademark Office, the disclosures of which are expressly incorporated herein by reference:

U.S. Patent Application Serial No. 60/446,617 filed on Feb. 11, 2003 and entitled “System for Coordination of Multi Beam Transit Radio Links for a Distributed Wireless Access System” [15741]

U.S. Patent Application Serial No. 60/446,618 filed on Feb. 11, 2003 and entitled “Rendezvous Coordination of Beamed Transit Radio Links for a Distributed Multi-Hop Wireless Access System” [15743]

U.S. Patent Application Serial No. 60/446,619 filed on Feb. 12, 2003 and entitled “Distributed Multi-Beam Wireless System Capable of Node Discovery, Rediscovery and Interference Mitigation” [15742]

U.S. Patent Application Serial No. 60/447,527 filed on Feb. 14, 2003 and entitled “Cylindrical Multibeam Planar Antenna Structure and Method of Fabrication” [15907]

U.S. Patent Application Serial No. 60/447,643 filed on Feb. 14, 2003 and entitled “An Omni-Directional Antenna” [15908]

U.S. Patent Application Serial No. 60/447,644 filed on Feb. 14, 2003 and entitled “Antenna Diversity” [15913]

U.S. Patent Application Serial No. 60/447,645 filed on Feb. 14, 2003 and entitled “Wireless Antennas, Networks, Methods, Software, and Services” [15912]

U.S. Patent Application Serial No. 60/447,646 filed on Feb. 14, 2003 and entitled “Wireless Communication” [15897]

U.S. Patent Application Serial No. 60/451,897 filed on Mar. 4, 2003 and entitled “Offsetting Patch Antennas on an Omni-Directional Multi-Facetted Array to allow Space for an Interconnection Board” [15958]

U.S. Patent Application Serial No. 60/453,011 filed on Mar. 7, 2003 and entitled “Method to Enhance Link Range in a Distributed Multi-hop Wireless Network using Self-Configurable Antenna” [15946]

U.S. Patent Application Serial No. 60/454,715 filed on Mar. 15, 2003 and entitled “Directive Antenna System in a Distributed Wireless Network” [15952]

U.S. Patent Application Serial No. 60/461,344 filed on Apr. 9, 2003 and entitled “Method of Assessing Indoor-Outdoor Location of Wireless Access Node” [15953]

U.S. Patent Application Serial No. 60/461,579 filed on Apr. 9, 2003 and entitled “Minimisation of Radio Resource Usage in Multi-Hop Networks with Multiple Routings” [15930]

U.S. Patent Application Serial No. 60/464,844 filed on Apr. 23, 2003 and entitled “Improving IP QoS though Host-Based Constrained Routing in Mobile Environments” [15807]

U.S. Patent Application Serial No. 60/467,432 filed on May 2, 2003 and entitled “A Method for Path Discovery and Selection in Ad Hoc Wireless Networks” [15951]

U.S. Patent Application Serial No. 60/468,456 filed on May 7, 2003 and entitled “A Method for the Self-Selection of Radio Frequency Channels to Reduce Co-Channel and Adjacent Channel Interference in a Wireless Distributed Network” [16101]

U.S. Patent Application Serial No. 60/480,599 filed on Jun. 20, 2003 and entitled “Channel Selection” [16146]

### FIELD OF THE INVENTION

This invention relates generally to array antennas, and, in particular, to the operation of such antennas.

### BACKGROUND OF THE INVENTION

In wireless communication networks, the capacities of wireless communication links between network nodes are dependent upon received signal power relative to noise and interference, often expressed as a signal to noise and interference ratio or SNIR. Received signal power is affected by such link characteristics as link length and physical obstructions or “shadowing”.

Directional antennas are commonly used to mitigate the effects of shadowing. However, antennas are often deployed in constrained locations such as on street lights, utility poles, and the like, and are therefore limited in size. Size limitations in turn limit the directionality of these antennas, which thereby renders the antennas more susceptible to interference.

Although conventional high gain directional antennas may increase received signal power, known manual alignment techniques by which such antennas are aligned with existing network nodes are labor intensive. For example, when a network node is added to a communication network, a new antenna may need to be added to and aligned at each existing network node with which the new network node is to communicate. Alternatively, a high gain antenna need not necessarily be implemented at both ends of each transit link between network nodes, but such transit links then do not fully derive the benefits of high gain directional antennas.

Further, high gain directional antennas, by their nature, are characterized by narrow radiation and reception patterns or beams. Beamwidth generally decreases with increasing gain. Whereas highly directional beams may improve SNIR and increase wireless link capacity, scan times to detect incoming communication signals from neighbouring network nodes tend to increase, particularly for network nodes that communicate with multiple other network nodes. For these nodes, a greater number of antennas are required to cover a full 360 degrees, and each antenna is typically scanned to detect incoming communications.

### SUMMARY OF THE INVENTION

A system for operating an array antenna having multiple antenna elements is provided in accordance with one aspect of the invention. The system includes a feeding port, signal shifters, and an adaptive beamformer. The signal shifters are connected to respective antenna elements. The adaptive beamformer distributes input signals from the feeding port to the signal shifters and combines output signals from the signal shifters for output to the feeding port in different operating modes. Each operating mode is associated with respective array antenna gain patterns having different beamwidths.

According to another aspect of the invention, a network node for a distributed wireless access network includes a steerable array antenna having multiple antenna elements and configurable beamwidth for establishing wireless transit radio links with neighbouring network nodes in the distributed wireless access network, signal shifters for respective connection to the antenna elements, and an adaptive beamformer. The adaptive beamformer distributes array antenna input signals to the signal shifters and combines array antenna output signals from the signal shifters in a wide beamwidth operating mode associated with an array antenna gain pattern having a first beamwidth and a narrow beamwidth operating mode associated with an array antenna gain pattern having a second beamwidth narrower than the first beamwidth.

In one embodiment, the adaptive beamformer includes multiple beamformers that distribute input signals from the feeding port to, and combine output signals from, particular ones of the signal shifters.

The signal shifters may be phase shifters or combined amplitude and phase shifters. For phase shifters, phase weights to steer a gain pattern of the array antenna in particular directions, toward network nodes in a distributed wireless access network, for example, are determined. In embodiments including combined phase and amplitude shifters, complex weights having both phase components and amplitude components to steer gain peaks and nulls in an array antenna gain pattern are determined.

In accordance with another aspect of the invention, a method of operating an array antenna having configurable beamwidth in a wireless communication network is provided. The method includes listening for communication requests using a first beamwidth of the array antenna, receiving a communication request identifying a destination wireless access routing point in the wireless communication network, forming a beam having a second beamwidth narrower than the first beamwidth, directing the formed beam toward the destination wireless access routing point, and transmitting communication signals over the formed beam to the destination wireless access routing point.

In a particular embodiment of the method, directing involves accessing a lookup table to retrieve phase shifts for antenna elements in the array antenna to steer the formed beam toward the destination wireless access routing point and applying the phase shifts to respective excitation signals of the antenna elements.

Another embodiment of the method includes determining a location of an interferer and directing a null toward the interferer. Directing a null toward the interferer may be accomplished by calculating phase and amplitude shifts for antenna elements in the array antenna to steer the null toward the interferer and applying the phase and amplitude shifts to respective excitation signals of the antenna elements.

According to yet another aspect of the invention, a system for operating an array antenna element in a wireless communication network is provided. The array antenna is excited to form a beam having a first beamwidth to listen for communication requests. After a communication request identifying a destination wireless access routing point in the wireless communication network is received, the array antenna is excited to form a beam having a second beamwidth narrower than the first beamwidth, and the formed beam is directed toward the destination wireless access routing point. Communication signals are then transmitted to the destination wireless access routing point over the beam having the second beamwidth.

A distributed wireless access network, in accordance with a still further aspect of the invention, includes network access nodes and wireless transit radio links between the network access nodes. At least one of the network access nodes has an electronically steerable high gain array antenna with configurable beamwidth for establishing wireless transit links with its neighbouring network access nodes.

Operation of an antenna system at such different beamwidths enables the benefits of both wide antenna beams and directional antenna beams to be realized. For example, wide antenna beams reduce scan times for detecting incoming communication signals, whereas narrow directional antenna beams generally have higher gains and may be preferred for communication signal transmission. Beam and null steering in accordance with some embodiments of the invention further reduce interference on wireless communication links.

Other aspects and features of the present invention will become apparent to those ordinarily skilled in the art upon review of the following description of the specific embodiments of the invention.

### BRIEF DESCRIPTION OF THE DRAWINGS

The invention will now be described in greater detail with reference to the accompanying diagrams, in which:

FIG. 1 is a block diagram of a distributed wireless communication network;

FIG. 2 is a block diagram of a wireless access routing point of FIG. 1;

FIG. 3 is a line drawing illustrating beam steering in a linear array antenna;

FIG. 4 is a block diagram of a patch array antenna and associated feed arrangement;

FIG. 5 is a plot of an example array antenna gain pattern for uniform antenna element excitation;

FIG. 6 is a plot of an example array antenna gain pattern for a nonuniform antenna element excitation;

FIG. 7 is a block diagram of an array antenna feed arrangement according to an embodiment of the invention; and

FIGS. 8-12 are plots of example array antenna gain patterns for excitation of different numbers of antenna elements.

### DETAILED DESCRIPTION OF PREFERRED EMBODIMENTS

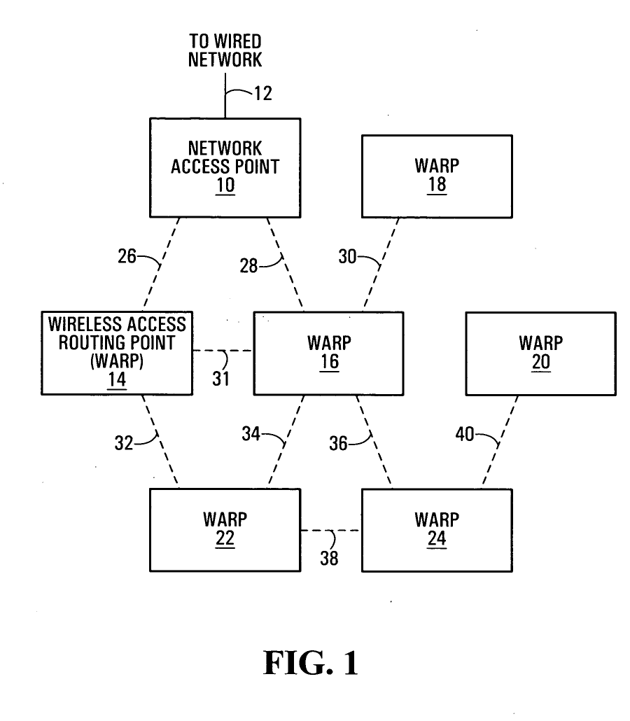

FIG. 1 is a block diagram of a distributed wireless communication network, in which the present invention may be implemented. The wireless communication network comprises a network access point (NAP) 10, connected to a wired network via a connection 12, a plurality of wireless access routing points (WARPs) 14, 16, 18, 20, 22, and 24, and a plurality of wireless transit links 26, 28, 30, 31, 32, 34, 36, 38, and 40. The network shown in FIG. 1 is one example of the type of communication network to which the present invention is applicable. The invention is in no way restricted to the network of FIG. 1, and may be implemented in other types of networks having different numbers and types of network nodes, including networks without a NAP or other connection to a wired network, for instance.

As shown, the NAP 10 is a network node that is connected to a wired backbone network such as the Internet through the connection 12, typically a broadband wireline connection.

The WARPs 14, 16, 18, 20, 22, and 24 route communication signals throughout the network, and possibly outside the network through the NAP 10, via transit links 26, 28, 30, 31, 32, 34, 36, 38, and 40. Although not explicitly shown in FIG. 1, those skilled in the art will appreciate that the WARPs also support a network access function allowing mobile stations to access the network.

Any of the WARPs 14, 16, 18, 20, 22, and 24 that require connection outside the local network shown in FIG. 1 must establish a connection through the NAP 10. As such, the capacity of the wireless transit links 26 and 28 is of critical importance and, in some instances, may represent a bottleneck in the network. Although antenna operation as described herein is particularly pertinent to such critical wireless links, it should be appreciated that the invention is in no way limited thereto.

As described above, the capacity of a wireless link is dependent upon its SNIR. In accordance with an aspect of the present invention described in further detail below, an adaptive array antenna is operated in one of a plurality of operating modes, including a wide beam scanning mode and a high gain directional operating mode that supports high capacity wireless links.

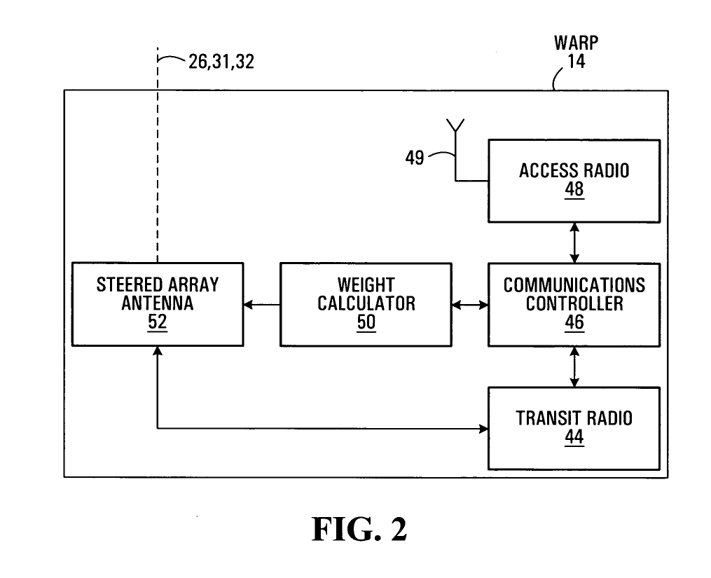

FIG. 2 is a block diagram of a wireless access routing point of FIG. 1. Each of the WARPs 16, 18, 20, 22, and 24 preferably has a similar structure to the WARP 14 shown in FIG. 2.

The WARP 14 comprises an access radio 48 connected to an access antenna 49, a communications controller 46 connected to the access radio 48, a weight calculator 50, and a transit radio 44, and a steered array antenna 52 connected to the transit radio 44 and the weight calculator 50. A WARP may also include further components that have not been shown in FIG. 2 to avoid congestion in the drawing.

The access radio 48 and the antenna 49 support a network access function for mobile stations (not shown) located within an access coverage area of the WARP 14. The access radio 48 performs such operations as communication signal frequency conversion, filtering, encoding and decoding, and modulation and demodulation, for example. The antenna 49 transmits communication signals to and receives communication signals from mobile stations, and comprises either a single antenna element or multiple antenna elements such as main and diversity antenna elements.

The operation of the communications controller 46 is dependent upon the design and configuration of the WARP 14. Generally, a communications controller handles such control functions as routing of communication signals between the transit radio 44 and the access radio 48 and control of scanning operations by the transit radio 44 and the access radio 48.

The transit radio 44 performs operations similar to those of the access radio 48, to support transit links to one or more other WARPs. However, the access radio 48 and the transit radio 44 typically employ different frequency bands, and possibly different encoding and modulation schemes. For example, in one embodiment, the access radio 48 is an 802.11b/g module operating at 2.4 GHz, whereas the transit radio 44 is an 802.11a module operating in the frequency band of 5.15 GHz to 5.85 GHz. Those skilled in the art will appreciate that “802.11” refers to a set of specifications, available from the Institute of Electrical and Electronics Engineers (IEEE) relating to wireless local area networks (LANs).

The steered array antenna 52 transmits and receives communication signals over the wireless transit links 26, 31, and 32. The array antenna 52 includes a plurality of antenna elements. Gain patterns of the individual antenna elements interfere both constructively and destructively to generate a resultant gain pattern of the array antenna 52. Beamwidth and direction of the resultant gain pattern are controllable, as described in further detail below, by applying phase weights to excitation signals of each antenna element.

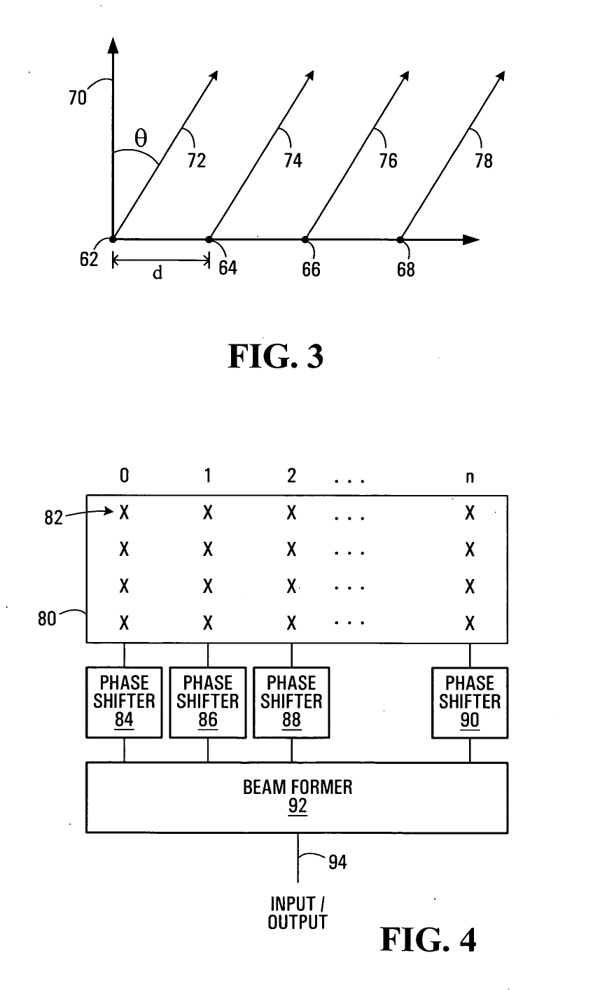

FIG. 3 is a line drawing illustrating beam steering in a linear array antenna. As shown, beams 72, 74, 76, and 78 from each antenna element 62, 64, 66, and 68 in a linear array antenna are steered in a beam pointing direction θ relative to boresight, indicated at 70. Beam steering is achieved by phase shifting antenna feed or excitation signals, which include both received and transmitted signals. Progressive phase shifts φₙ between antenna elements in an array antenna are calculated, by the weight calculator 50 in FIG. 2, for example, according to the following formula:

φₙ=n*(2π/λ)d*sin θ,

where n=0, 1, . . . , n for an array antenna having n+1 elements, λ is wavelength associated with an operating frequency of the array antenna, and d is the spacing between antenna elements. Where an array antenna is operable within a range of frequencies, λ is preferably the minimum wavelength λₘᵢₙ associated with the maximum operating frequency. For the four-element array antenna shown in FIG. 3, the phase weights for the antenna elements 62, 64, 66, and 68 are 0, (2π/λ)d*sin θ, (4π/λ)d*sin θ, and (6π/λ)d*sin θ, respectively.

For any distance d between antenna elements, there is a maximum useful beam steering angle θₘₐₓ. For beam pointing angles beyond the maximum steering angle, so-called grating lobes appear in the antenna gain pattern. However, grating lobes can be reduced by establishing the distance d as follows:

d≦λₘᵢₙ/(1+sin|θₘₐₓ|).

In a preferred embodiment of the invention, the transit radio 44 (FIG. 2) is an 802.11a module with a maximum operating frequency of 5.85 GHz. For a +/−60 degree beam scan (i.e., |θₘₐₓ|=60 degrees), antenna element spacing is approximately 27 mm. This antenna element spacing restricts the type of antenna elements that may be used, in that the antenna elements must be relatively small in the horizontal plane. Vertically polarized dipole antennas represent one example of a type of antenna element that can be used to realize such an array antenna. With a +/−60 degree beam scan, three such array antennas arranged in a triangle cover a full 360 degrees. A reduced scan range of +/−45 degrees allows for a larger antenna element spacing and thus an easier to achieve design, but requires four array antennas instead of three to cover 360 degrees. Of course, other beam scan ranges can also be used.

Another alternative antenna element structure is a patch antenna. FIG. 4 is a block diagram of a patch array antenna and associated feed arrangement.

The patch array antenna 80 includes a plurality of radiating elements 82 arranged in 4 rows and n+1 columns. The feed arrangement includes a feeding port 94, a beamformer 92, and one phase shifter 84, 86, 88, and 90 per column.

Phase shifters are commercially available and are typically characterized by a number of control bits. For example, a 6-bit phase shifter has phase steps of 360/2⁶, or 5.625 degrees. The phase shifters 84, 86, 88, and 90 are selected to ensure that the quantization phase steps are sufficiently small to provide desired antenna beamwidth and pointing accuracy. The phase shifts applied by the phase shifters 84, 86, 88, and 90 are controlled by phase weights calculated and supplied by a weight calculator such as the weight calculator 50 of FIG. 2.

During a transmit operation, the beamformer 92 distributes an excitation signal received on the feeding port 94 to the phase shifters 84, 86, 88, and 90. In a similar manner, the beamformer 92 combines signals received from the phase shifters 84, 86, 88, and 90 and provides output signals on the feeding port 94.

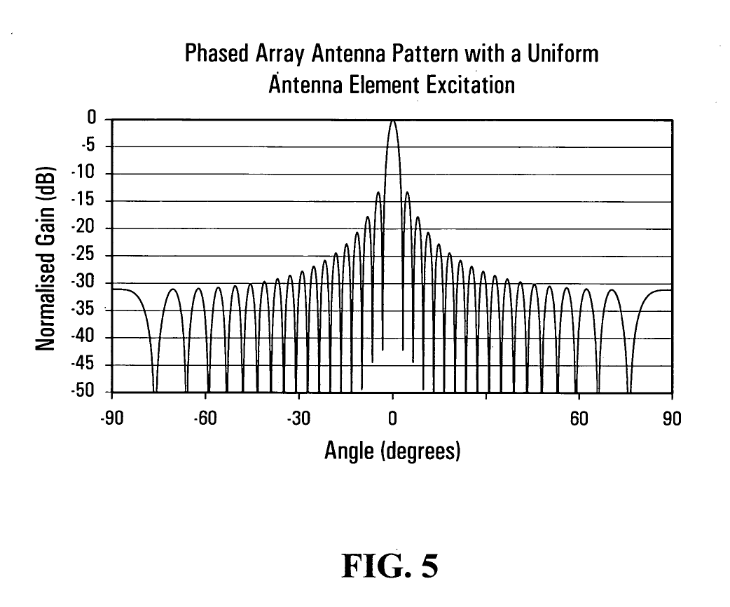

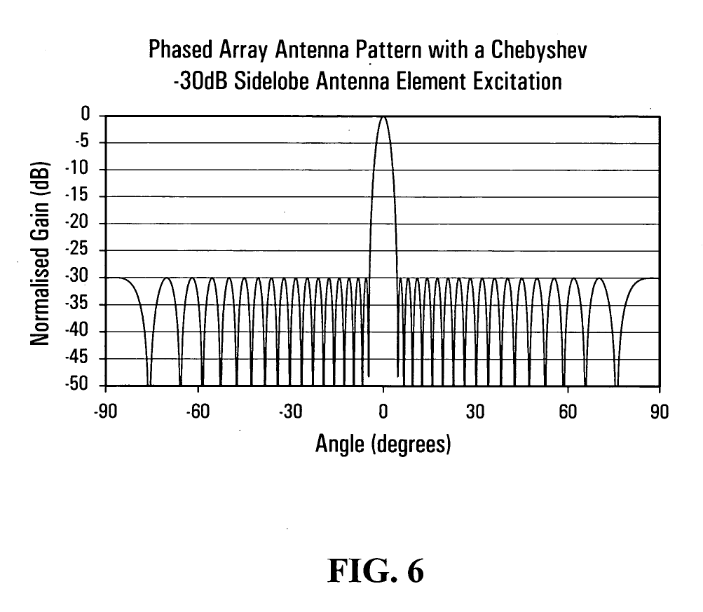

Several design options for the beamformer 92 will be apparent to those skilled in the art. In perhaps its simplest implementation, the beamformer 92 is an equal power divider/combiner, providing the highest possible gain. FIG. 5 is a plot of an example array antenna gain pattern for such a uniform antenna element excitation. Although uniform excitation typically provides highest possible gain, sidelobe levels are approximately 13 dB below the peak gain. In some embodiments, the beamformer 92 can be configured to apply an amplitude taper across the array antenna 80 to reduce sidelobe levels and thus provide increased immunity to interference, albeit at the expense of slightly reduced peak gain. FIG. 6 is a plot of an example array antenna gain pattern for a nonuniform antenna element excitation that achieves sidelobe levels at 30 dB below peak gain. Further alternative beamformers will be apparent to those skilled in the art to which the present invention pertains.

For a patch array antenna, maximum achievable gain is typically determined as:

G=4πA_{eff}/λ²,

Where A_{eff}=effective area of the patch array antenna.

As an example, consider a patch array antenna operated at a centre frequency of 5.4 GHz and wherein elements are arranged in four rows spaced at 0.75λ with 36 columns spaced 27 mm apart to allow +/−60 degree scanning. A_{eff}=height*width=(4*42)*(36*27)=168 mm*972 mm=0.16 m². With an assumed efficiency of 50%, actual gain is approximately 25.2 dBi, which represents a link budget gain of over 10 dB relative to typical gains of about 14 dBi for conventional antennas. Transit links established using such array antennas can thereby either be operated at greater range or significantly higher data rates.

A patch array antenna may also be implemented, for example, with dielectrically loaded dual polarized patch antenna elements. In this configuration, dielectric loading reduces the size of the patch for resonance, thereby enabling smaller element spacing and reducing grating lobes. Dual polarized patches also provide for such further benefits as individual beam steering, polarization diversity for both transmit and receive operations, and implementation of multiple input multiple output (MIMO). In a dual polarized array antenna, a feeding port, a beamformer, and a plurality of phase shifters are preferably provided for each of vertical and horizontal polarizations or other orthogonal polarizations.

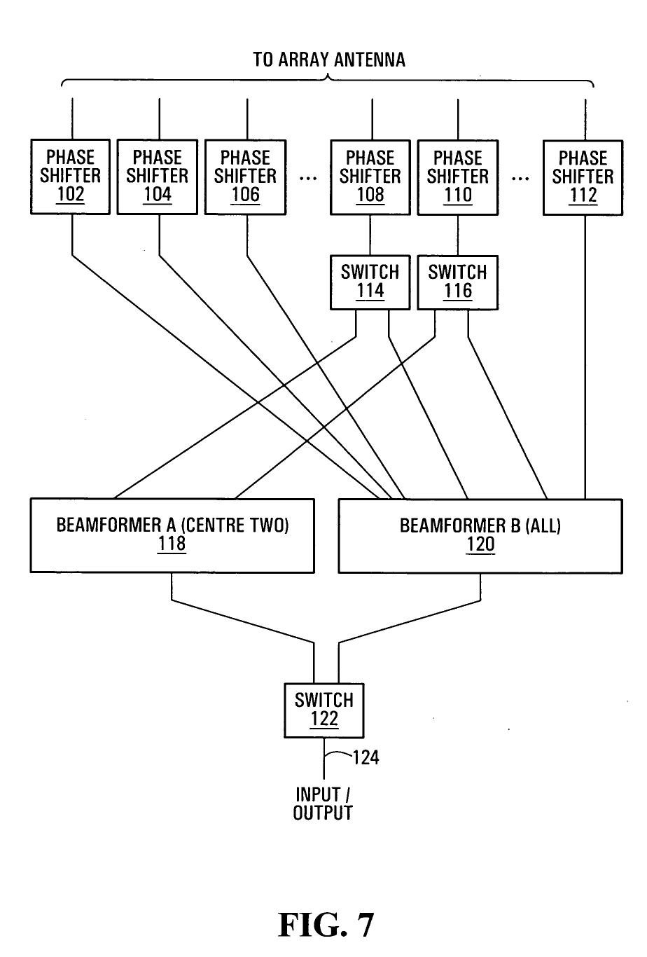

FIG. 7 is a block diagram of an array antenna feed arrangement according to an embodiment of the invention. The feed arrangement includes a phase shifter 102, 104, 106, 108, 110, and 112 for each antenna element in the array antenna, or for each column of antenna elements in a patch array antenna, a plurality of switches 114 and 116, a plurality of beamformers 118 and 120, an input/output switch 122, and a feeding port 124. The beamformers 118 and 120 and the switches 114, 116, and 122 represent one implementation of an adaptive beamformer which, as described in further detail below, distributes input signals from the feeding port 124 to the phase shifters 102-112 and combines output signals from the phase shifters 102-112 for output to the feeding port 124. In alternate embodiments, the adaptive beamformer and the phase shifters 102-112 are implemented digitally, with frequency upconverting for signals to be transmitted and frequency downconverting for received signals.

The phase shifters 102-112 operate substantially as described above, applying phase shifts dependent upon phase weights received from a weight calculator.

In FIG. 7, both of the beamformers 118 and 120 are configured to process signals for the centre two phase shifters 108 and 110 and their associated antenna elements, but only one beamformer, 120, is configured to process signals for the remaining phase shifters and associated antenna elements. The switches 114 and 116 provide for selection of either the beamformer 118 or the beamformer 120. Similarly, the input switch 122 routes an input signal to or an output signal from a selected one of the beamformers 118 and 120.

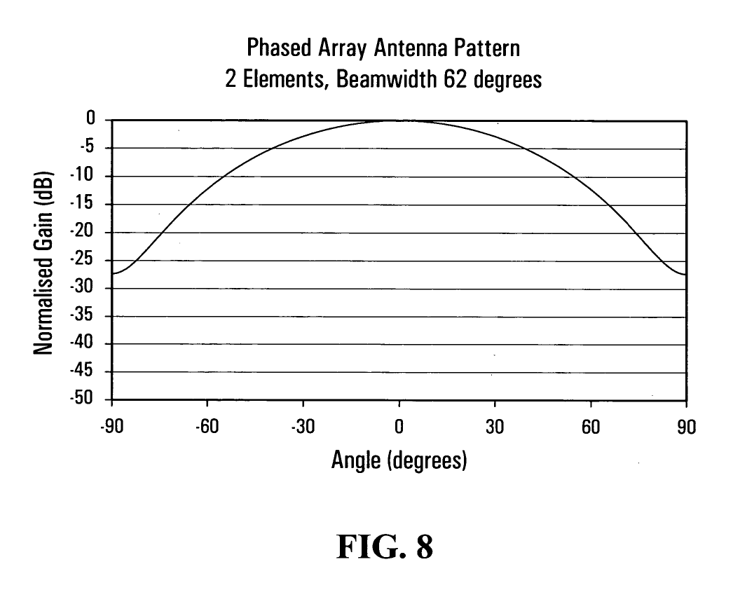

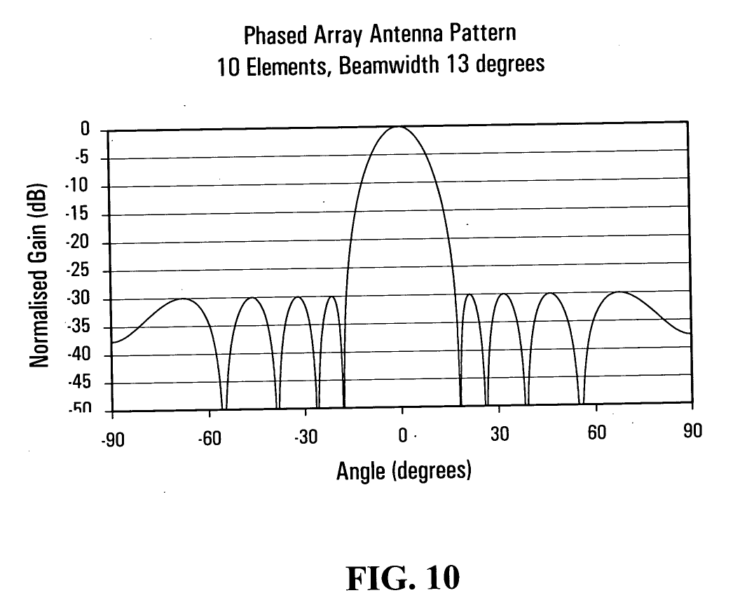

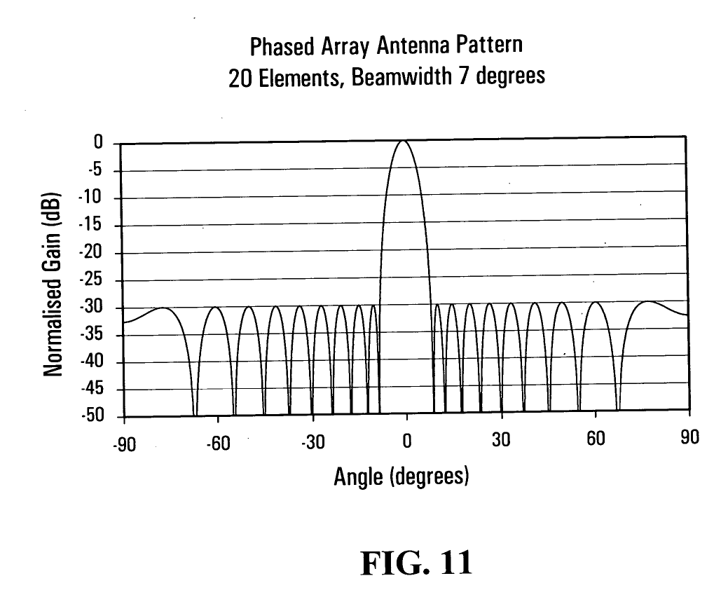

As described above, high gain directional antennas are desirable for increasing signal power and reducing interference, but can increase scan times for detecting incoming connection or link requests from a neighbouring WARPs. In the system of FIG. 7, the beamformers 118 and 120 provide for different operating modes of an array antenna. During a scan operation, a wide beamwidth operating mode is selected, whereas during communication operations in which communication signals are being transmitted or received, a more directional narrow beamwidth operating mode is preferably selected. Beamwidth effects of different array antenna excitations will become apparent from the following description and FIGS. 8-12, which are plots of array antenna gain patterns for excitation of different numbers of antenna elements. The plots in FIGS. 8-12 represent gain patterns for the above example 4 row by 36 column patch array antenna.

As shown in FIG. 8, selection of the beamformer 118, associated with excitation of only the centre two antenna elements in an array antenna, results in a relatively large beamwidth of 62 degrees. In this example, a full 360 degree scan is achieved with three array antennas. This wide beamwidth is used, for example, in a scanning mode to await the arrival of a transit link request from a neighbouring WARP, thereby reducing scan times relative to known directional antenna implementations, or in other situations in which a wide beamwidth is desirable.

For communication operations, a more directional antenna pattern is generally preferred to increase received signal power and reduce interference. When a transit link request from a neighbouring WARP or a communication signal from a mobile station within an access area of a WARP is received, for example, a high gain directional operating mode is preferably selected. For a transit link request, an identifier of the requesting WARP is decoded from the request, and a previously generated lookup table or other mapping means from which the phase weights associated with steering a beam toward neighbouring WARPs can be retrieved or determined is accessed. Phase weights for neighbouring WARPs may be manually determined and stored, for example, when a WARP is installed in a network. In another embodiment, a WARP is configured to discovery its neighbouring WARPs to populate a lookup table. Discovery techniques are disclosed, for example, in the co-pending and commonly assigned U.S. patent application Ser. No. ______ <Attorney Docket No. 71493-1196>, entitled “Distributed Multi-Beam Wireless System”, and filed of even date herewith, the entire contents of which are hereby incorporated herein by reference. Other schemes for determining a location of a neighbouring WARP may also be apparent to those skilled in the art, and as such are considered to be within the scope of the present invention.

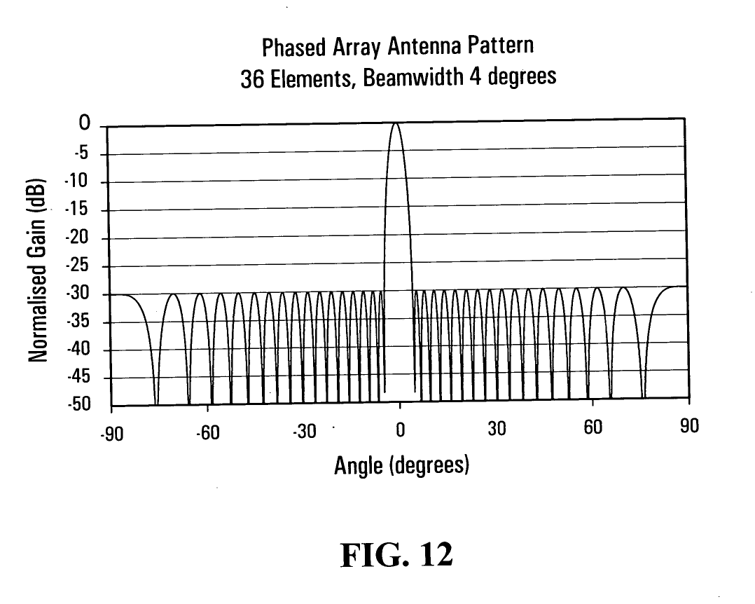

The phase weights required to steer the antenna pattern in the direction of the neighbouring WARP are retrieved from the lookup table and applied to the phase shifters 102-112. The beamformer 120 is selected, and the switches 122, 114, and 116 are set accordingly. As shown in FIG. 12, excitation of all 36 antenna elements results in a much narrower beamwidth of 4 degrees, steered in the direction of the appropriate neighbouring WARP. The high gain and low interference enables high data rate communications over the wireless link.

Thus, an array antenna operated in this manner has configurable beamwidth. A wide beamwidth operating mode is useful for such functions as scanning or listening for incoming communication traffic or link requests. The high gain directional or narrow beamwidth operating mode for communication functions simultaneously increases received signal power and reduces interference. Both operating modes are provided using a single antenna structure and phase shifters.

Beamformer selection, switch control, and thus radiation pattern selection, are preferably performed by a communications controller, a transit radio, or some other WARP component dependent upon a current or desired operating mode.

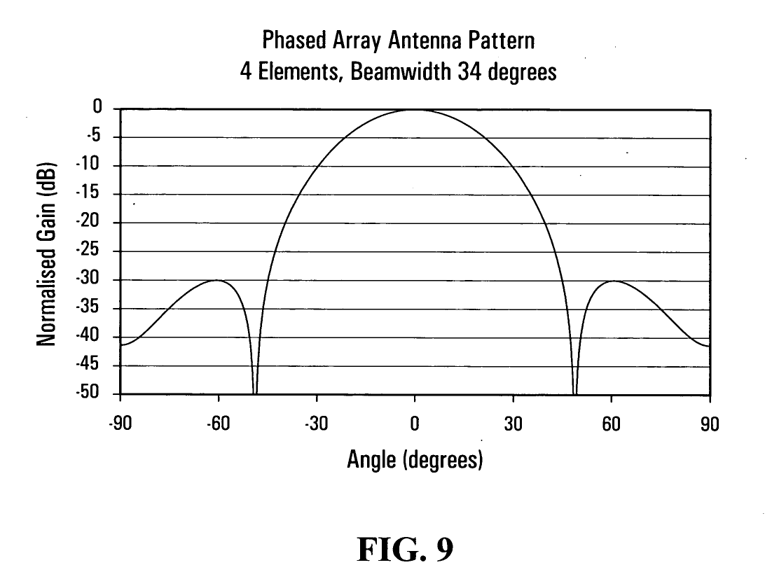

In further embodiments, operating modes use other than the two centre antenna elements and all of the antenna elements indicated in FIG. 7. FIGS. 9-11 illustrate array antenna gain patterns associated with using 4, 10, and 20 antenna elements, respectively, of the same patch array antenna for which the plots of FIGS. 8 and 12 were generated.

In another embodiment, further intermediate beamformers are provided in an array antenna feeding system. In such systems, more than two operating modes are supported. For instance, it is known that in distributed wireless access networks, links that are not line-of-sight may have many reflections, and many propagation paths exist between a transmitting network node and a receiving network node. If too narrow a beamwidth is selected for such a link, then some of the paths are not excited, and hence additional losses may occur. Accordingly, where several narrow beamwidth beamformers are provided, the beamformer that provides the best link gain available can be selected. Selection of a beamformer is then dependent upon the propagation characteristics of a link between particular WARPs at the time of use. In one possible implementation, current propagation characteristics are determined and a beamformer is selected, or a different beamformer is selected, based on those characteristics. Previous beamformer selections for a particular neighbour WARP may also be recorded, in the lookup table described above, for example, and used in subsequent communications involving that WARP.

In a still further embodiment, a software-based beamformer module is provided. The beamformer module selects one of a plurality of beamforming algorithms depending upon a current operating mode, provides outputs to or accepts inputs from particular phase shifters as appropriate, and thus does not require the switches 114, 116, and 122. The functionality of the phase shifters 102-112 may also be integrated into such a beamformer module.

The array antenna operation techniques described above use a wide beamwidth for scanning or listening, to locate a source of incoming communication traffic, and a narrow beamwidth for sending or receiving traffic. A wide beam locates a source, and then antenna gain is effectively steered towards the source or to a destination for transmission operations. According to a further aspect of the invention, nulls are placed in an antenna pattern in the direction of interferers, to thereby reduce interference.

Antenna gain in an array antenna is steered using phase shifts between antenna elements, as described above. Nulls are also steerable, but using amplitude shifts or offsets in addition to phase shifts. In the case of an interferer having a fixed location relative to a WARP, after the location of the interferer has been determined, either manually or using the wide beamwidth operating mode for instance, complex weights including phase weights and amplitude weights are calculated. The amplitude weights are applied to excitation signals in the beamformers or in separate amplitude shifters or amplifiers, for example. The complex weights for such fixed interferer nulls, like WARP phase weights, can be stored and retrieved for use in subsequent communication operations.

The wide beamwidth operating mode described above may also be used to locate transient interferers. Transient interferers include interference sources that have no fixed location, a bursty or otherwise discontinuous signalling pattern, or both. Provided the location of such an interferer is determined during a wide beamwidth operating mode, complex weights can be applied to generate a null in the direction of the interferer. Weights associated with such transient interferers may or may not be stored, depending upon system configuration and/or system owner or designer preferences.

Although gain steering and null steering are substantially independent in that each involves a different set of weights, both techniques may be implemented in conjunction with the same antenna. In this instance, phase weights for beam steering and complex weights for null steering are independently calculated and applied to antenna excitation signals as described above. In a preferred embodiment, the phase weights and complex weights are combined after calculation and then applied to excitation signals.

Antenna operation techniques in accordance with aspects of the present invention provide the advantages of high gain and narrow beamwidth during communication operations, while avoiding the scanning or listening time delays associated with conventional high gain antennas. High gain and narrow beamwidth allow longer link ranges to be achieved without interfering with other nodes in a distributed communication network. As such, network routers such as the WARPs described above are able to direct network traffic to nodes that may otherwise be more than one “hop” away. Multi-hop routing thereby becomes more practical.

Where nodes of a distributed network are located in close proximity and form a dense cluster, power control is often used to reduce the transmitted power to avoid interference between nodes. Operation of an antenna in a high gain and narrow beamwidth mode both maintains the link budget of each wireless link associated with the nodes in the cluster and provides increased immunity to interference between the nodes during communication operations.

What has been described is merely illustrative of the application of the principles of the invention. Other arrangements and methods can be implemented by those skilled in the art without departing from the spirit and scope of the present invention.

For example, although reference is made to a phase weight lookup table stored at a WARP for its neighbouring WARPs, bearing angles may also or instead be stored and retrieved from such a lookup table, and used to calculate appropriate phase weights when a communication link is to be established between WARPs.

In addition, antenna operation systems and methods have been described primarily in the context of network nodes that provide both access and transit functions. However, it should be appreciated that the present invention is applicable to wireless links in general. A network node need not necessarily support access functions.

What is claimed is:

1. A system for operating an array antenna, the array antenna having a plurality of antenna elements, comprising:
a feeding port;
a plurality of signal shifters for respective connection to the plurality of antenna elements; and
an adaptive beamformer configured to distribute input signals from the feeding port to the plurality of signal shifters and to combine output signals from the plurality of signal shifters for output to the feeding port in a plurality of operating modes, the plurality of operating modes being associated with respective array antenna gain patterns having different beamwidths.

2. The system of claim 1, wherein the adaptive beamformer comprises a plurality of beamformers, each beamformer distributing input signals from the feeding port to, and combining output signals from, particular ones of the plurality of signal shifters.

3. The system of claim 2, wherein the plurality of beamformers comprises a first beamformer for distributing input signals from the feeding port to, and combining output signals from, each of the plurality of signal shifters, and a second beamformer for distributing input signals from the feeding port to, and combining output signals from, a subset of the plurality of signal shifters.

4. The system of claim 3, wherein the subset of the plurality of signal shifters comprises signal shifters for connection to two centre antenna elements of the plurality of antenna elements.

5. The system of claim 2, wherein the adaptive beamformer further comprises an input switch connected to the feeding port and to the plurality of beamformers for switching signals between any one of the plurality of beamformers and the feeding port.

6. The system of claim 3, wherein the adaptive beamformer further comprises:
an input switch connected to the feeding port and to the plurality of beamformers; and
a plurality of switches connected to the first beamformer and the second beamformer and respectively connected to each signal shifter in the subset of the plurality of signal shifters, each of the plurality of switches operable to connect each signal shifter in the subset of the plurality of signal shifters to either the first beamformer or the second beamformer.

7. The system of claim 1, further comprising:
a signal weight calculator configured to calculate signal weights for steering a gain pattern of the array antenna and to output the signal weights to the signal shifters.

8. The system of claim 7, implemented in a network node of a distributed wireless access network, wherein the signal shifters are phase shifters, and wherein the signal weights are phase weights calculated to steer a gain peak in the gain pattern of the array antenna in a direction of a neighbouring network node in the distributed wireless access network.

9. The system of claim 8, wherein the network node further comprises a memory storing a lookup table comprising phase weights for steering the gain peak in the gain pattern of the array antenna in a direction of each neighbouring network node of the network node.

10. The system of claim 7, implemented in a network node of a distributed wireless access network, wherein the signal shifters are combined amplitude and phase shifters, and wherein the signal weights are complex weights comprising amplitude components and phase components calculated based on a location of an interference source in the distributed wireless access network to steer a null in the gain pattern of the array antenna in a direction of the interference source.

11. The system of claim 7, implemented in a network node of a distributed wireless access network, wherein the signal shifters are combined amplitude and phase shifters, and wherein the signal weights are complex weights comprising amplitude components and phase components calculated to steer a null in the gain pattern of the array antenna in a direction of an interference source in the distributed wireless access network and to steer a gain peak in the gain pattern of the array antenna in a direction of a neighbouring network node in the distributed wireless access network.

12. The system of claim 1, wherein the array antenna comprises a patch array antenna, and wherein the plurality of antenna elements comprises a plurality of columns of radiating elements.

13. The system of claim 1, wherein the plurality of operating modes comprises at least a first operating mode associated with a first array antenna gain pattern having a first beamwidth and a second operating mode associated with a second array antenna gain pattern having a second beamwidth narrower than the first beamwidth.

14. The system of claim 13, implemented in a network node of a distributed wireless access network, the network node having at least one neighbouring network node, wherein the adaptive beamformer operates in the first operating mode to scan for communication requests from the at least one neighbouring node of the network node, and in the second operating mode for communicating with the at least one neighbouring node.

15. A network node for a distributed wireless access network, comprising:
a steerable array antenna having a plurality of antenna elements and configurable beamwidth for establishing wireless transit radio links with neighbouring network nodes in the distributed wireless access network;
a plurality of signal shifters for respective connection to the plurality of antenna elements; and
an adaptive beamformer for distributing array antenna input signals to the plurality of signal shifters and combining array antenna output signals from the plurality of signal shifters in at least a wide beamwidth operating mode associated with an array antenna gain pattern having a first beamwidth and a narrow beamwidth operating mode associated with an array antenna gain pattern having a second beamwidth narrower than the first beamwidth.

16. The network node of claim 15, wherein the adaptive beamformer comprises at least a first beamformer for distributing input signals to and combining output signals from a subset of the plurality of signal shifters in the wide beamwidth operating mode, and a second beamformer for distributing input signals to and combining output signals from each of the plurality of signal shifters in the narrow beamwidth operating mode.

17. The network node of claim 15, wherein the signal shifters are phase shifters, further comprising:
a phase weight calculator configured to calculate phase weights for steering a gain peak in the array antenna gain pattern having the second beamwidth toward one of the neighbouring nodes, and to output the phase weights to the phase shifters in the narrow bandwidth operating mode.

18. The network node of claim 15, wherein the signal shifters are phase shifters, further comprising:
a complex weight calculator configured to calculate complex weights comprising phase weights and amplitude weights for steering a null in the array antenna gain pattern having the second beamwidth toward an interference source in the distributed wireless access network, and to output the phase weights to the phase shifters and the amplitude weights to the second beamformer in the narrow bandwidth operating mode.

19. The network node of claim 15, wherein the array antenna is operated in the wide beamwidth operating mode during a listening function to scan the neighbouring network nodes and in the narrow beamwidth operating mode during a communication function over a wireless transit radio link.

20. A method of operating an array antenna in a wireless communication network, the array antenna having configurable beamwidth, comprising:
listening for communication requests using a first beamwidth of the array antenna;
receiving a communication request identifying a destination wireless access routing point in the wireless communication network;
forming a beam having a second beamwidth narrower than the first beamwidth;
directing the formed beam toward the destination wireless access routing point; and
transmitting communication signals over the formed beam to the destination wireless access routing point.

21. The method of claim 20, wherein the array antenna comprises a plurality of antenna elements, and listening comprises exciting a subset of the plurality of antenna elements.

22. The method of claim 21, wherein forming comprises exciting each of the plurality of antenna elements.

23. The method of claim 20, wherein directing comprises:
accessing a lookup table to retrieve phase shifts for the plurality of antenna elements to steer the formed beam toward the destination wireless access routing point; and
applying the phase shifts to respective excitation signals of the plurality of antenna elements.

24. The method of claim 22, wherein directing comprises:
calculating phase shifts for the plurality of antenna elements to steer the formed beam toward the destination wireless access routing point; and
applying the phase shifts to respective excitation signals of the plurality of antenna elements.

25. The method of claim 20, further comprising:
determining a location of an interferer; and
directing a null toward the interferer.

26. The method of claim 25, wherein determining a location of an interferer comprises accessing a lookup table to retrieve a bearing angle of the interferer.

27. The method of claim 25, wherein determining a location of an interferer comprises scanning a wireless access area.

28. The method of claim 25, wherein directing a null toward the interferer comprises:
calculating phase shifts and amplitude shifts for the plurality of antenna elements to steer the null toward the interferer; and
applying the phase shifts and the amplitude shifts to respective excitation signals of the plurality of antenna elements.

29. A system for operating an array antenna element in a wireless communication network, comprising:
means for exciting the array antenna to form a beam having a first beamwidth to listen for communication requests;
means for receiving a communication request identifying a destination wireless access routing point in the wireless communication network;
means for exciting the array antenna to form a beam having a second beamwidth narrower than the first beamwidth, and for directing the formed beam toward the destination wireless access routing point; and
means for transmitting communication signals over the beam having the second beamwidth to the destination wireless access routing point.

30. A distributed wireless access network, comprising:
a plurality of network access nodes; and
a plurality of wireless transit radio links between the network access nodes,
wherein at least one of the network access nodes comprises an electronically steerable high gain array antenna with configurable beamwidth for establishing wireless transit links with neighbouring network access nodes.

31. The network of claim 30, wherein at least one of the network access nodes is connected to a broadband wireline backbone connection.

32. The network of claim 30, wherein the beamwidth of the array antenna is controlled by different excitations of the array antenna.

33. The network of claim 30, wherein the array antenna comprises a plurality of diversity transceivers.

34. The network of claim 33, wherein the diversity transceivers are dual polarized diversity transceivers, and wherein beams for each polarization direction of the diversity transceivers are steered independently.

35. The network of claim 30, wherein the beamwidth of the array antenna is configurable to provide decreased probability of interference.
